(19) United States
(12) Patent Application Publication
(10) Pub. No.: US 2019/0351593 A1
(43) Pub. Date: Nov. 21, 2019

(54) Foam molding device

(71) Applicant: Pou Chen Corporation, Chang Hwa Hsien (TW)

(72) Inventors: Hung-Wu Hsieh, Xizhou Township (TW); Shih-Chia Lin, Yuanlin City (TW); Shao-Wei Jen, Chang Hwa Hsien (TW); Chien-Jung Hung, Chang Hwa Hsien (TW); Tsung-Wei Kuo, Changhua City (TW); Ju-Cheng Chen, Tainan City (TW)

(21) Appl. No.: 15/999,541

(22) Filed: Aug. 20, 2018

(30) Foreign Application Priority Data
May 17, 2018 (TW) 107116825

(51) Int. Cl. B29C 44/42; B29C 44/34; B29C 44/58

(52) U.S. Cl. CPC B29C 44/428; B29C 44/3415; B29K 2105/04; B29C 44/35; B29C 44/58

(57) ABSTRACT

A foam molding device includes an outer mold unit and an inner mold unit. The outer mold unit includes an outer upper mold and an outer lower mold that cooperatively define a receiving space. The inner mold unit is detachably disposed within the receiving space, and includes an inner upper mold and an inner lower mold. The inner upper mold and the inner lower mold cooperatively define a foaming space adapted for foam molding a foam material into a foamed object.

### CROSS-REFERENCE TO RELATED APPLICATION

This application claims priority of Taiwanese Invention Patent Application No. 107116825, filed on May 17, 2018.

### FIELD

The disclosure relates to a molding device, and more particularly to a foam molding device.

### BACKGROUND

Traditional footwear such as shoes and boots generally uses rubber as a material to make soles. However, high density of rubber would increase the weight of manufactured footwear, which therefore might not satisfy the current lightweight requirement for sports shoes, casual shoes, etc.

Currently, the footwear industry has developed foamed soles with combined features, such as shock-absorbing, softness and lightness. Taiwanese Invention Patent No. I614111 discloses a method of manufacturing a foamed sole. Due to the use of supercritical fluids in the method of the patent, after completion of the foam molding process, the resultant foamed sole composed of a thermoplastic polymer will have a temperature that is above the glass transition temperature of its starting material (i.e., thermoplastic polyurethane or thermoplastic polyester elastomer). If the foamed sole is removed from the mold after the foam molding process, the foamed sole will continue to foam and expand, causing difficulty in controlling its size. If the foamed sole is to be cooled to a temperature that is below the glass transition temperature of its starting material before being removed from the mold, the manufacturing time of the foamed sole might be prolonged, thus incurring a higher manufacturing cost.

### SUMMARY

Therefore, an object of the disclosure is to provide a foam molding device that can alleviate at least one of the drawbacks of the prior art.

According to the disclosure, a foam molding device includes an outer mold unit and an inner mold unit. The outer mold unit includes an outer upper mold and an outer lower mold that cooperatively define a receiving space. The inner mold unit is detachably disposed within the receiving space, and includes an inner upper mold and an inner lower mold. The inner upper mold and the inner lower mold cooperatively define a foaming space adapted for foam molding a foam material into a foamed object.

### BRIEF DESCRIPTION OF THE DRAWINGS

Other features and advantages of the disclosure will become apparent in the following detailed description of the embodiment(s) with reference to the accompanying drawings, of which:

FIG. 1 is an exploded perspective view showing an embodiment of a foam molding device according to the present disclosure;

FIG. 2 is a schematic sectional view of the foam molding device of the embodiment; and

FIG. 3 is a flowchart illustrating consecutive steps of manufacturing a foamed midsole using the foam molding device of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

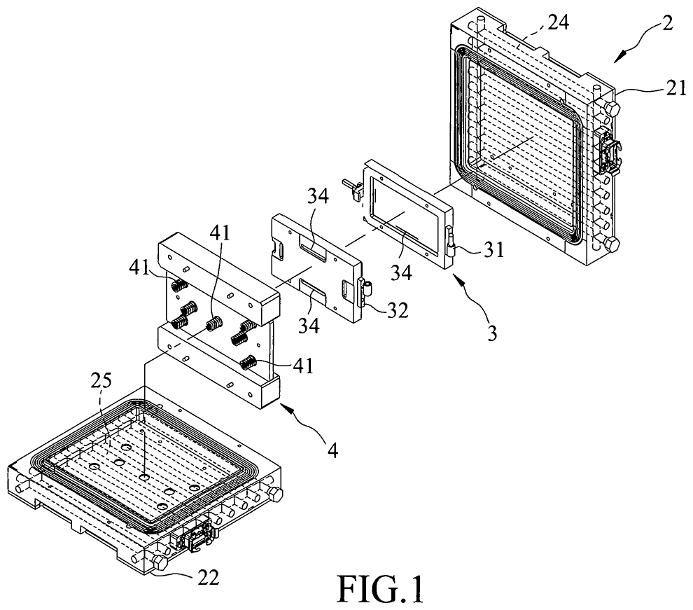

Referring to FIGS. 1, 2 and 3, an embodiment of a foam molding device according to the present disclosure is adapted for manufacturing a foamed object, such as a foamed midsole (not shown in the figures). The foam molding device includes an outer mold unit 2, an inner mold unit 3 and an ejection unit 4. Examples of a foam material for manufacturing the foamed object may include, but not be limited to, ethylene vinyl acetate (EVA) copolymers, polyolefin elastomers (POE), thermoplastic elastomers (TPE), and combinations thereof. The thermoplastic elastomers (TPE) may be thermoplastic polyurethane elastomers (TPUE).

The outer mold unit 2 includes an outer upper mold 21 and an outer lower mold 22. The outer upper mold 21 and the outer lower mold 22 cooperatively define a receiving space 23.

The outer mold unit 2 further includes an upper flow module 24 and a lower flow module 25. The upper flow module 24 is disposed inside the outer upper mold 21, and is configured to heat the outer upper mold 21. The lower flow module 25 is disposed inside the outer lower mold 22, and is configured to heat the outer lower mold 22. For example, in certain embodiments, the upper flow module 24 and the lower flow module 25 may introduce hot water or alternatively, may utilize an electric heating pipe to provide thermal energy. When cooling is needed, the upper flow module 24 and the lower flow module 25 may introduce cold water to dissipate the thermal energy.

The inner mold unit 3 is detachably disposed in the receiving space 23, and includes an inner upper mold 31 and an inner lower mold 32. The inner upper mold 31 and the inner lower mold 32 cooperatively define a foaming space 33. The foaming space 33 is adapted for foam molding the foam material into the foam object (not shown in the figures).

According to this disclosure, the inner mold unit 3 further includes at least one pressure relief hole 34 that is in spatial communication with inside and outside of the foaming space 33. In this embodiment, two pressure relief holes 34 are formed within each of the inner upper mold 31 and the inner lower mold 32. It should be noted that, the total number of the pressure relief holes 34 in the inner mold unit 3 can be adjusted according to actual needs.

According to this disclosure, the outer mold unit 2 may have a pressure resistance that is greater than that of the inner mold unit 3, and the inner mold unit 3 may have a thermal conductivity that is greater than that of the outer mold unit 2.

In certain embodiments, the outer mold unit 2 has a pressure resistance that is higher than 1000 pounds per square inch (psi), and is made of a steel material. In certain embodiments, the inner mold unit 3 has a thermal conductivity that is higher than 50 watts/meter Kelvin (W/mK), and is made of an aluminum material.

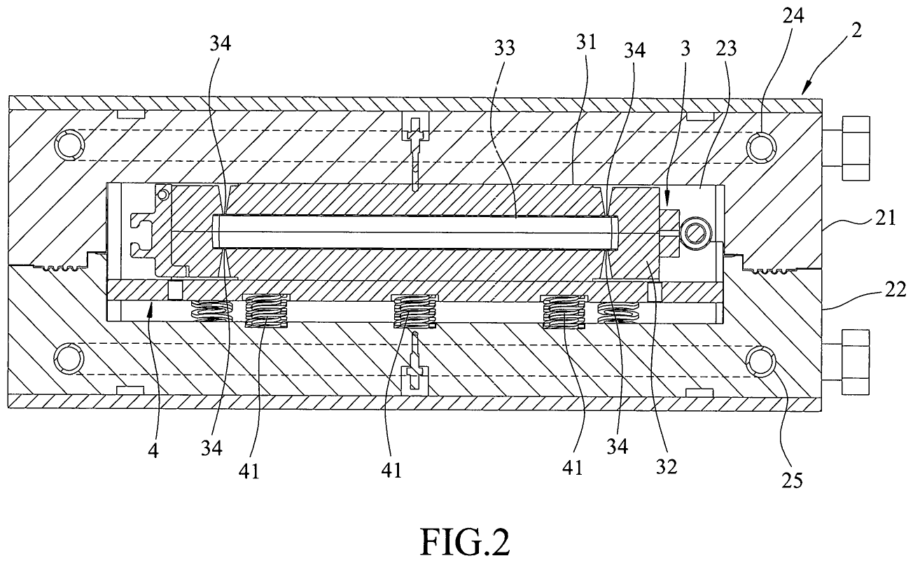

The ejection unit 4 is disposed in the receiving space 23 to provide a force for pushing the inner mold unit 3 away from the outer lower mold 22 upon opening the outer mold unit 2. The ejection unit 4 includes at least one elastic member 41 disposed between the outer lower mold 22 and the inner mold 3. As shown in FIGS. 1 and 2, in this embodiment, the ejection unit 4 includes a plurality of the elastic members 41 that are springs configured to provide an elastic force for pushing the inner mold unit 3 away from the outer lower mold 22. It should be noted that, the ejection unit 4 may also be a pressure cylinder, but is not limited thereto.

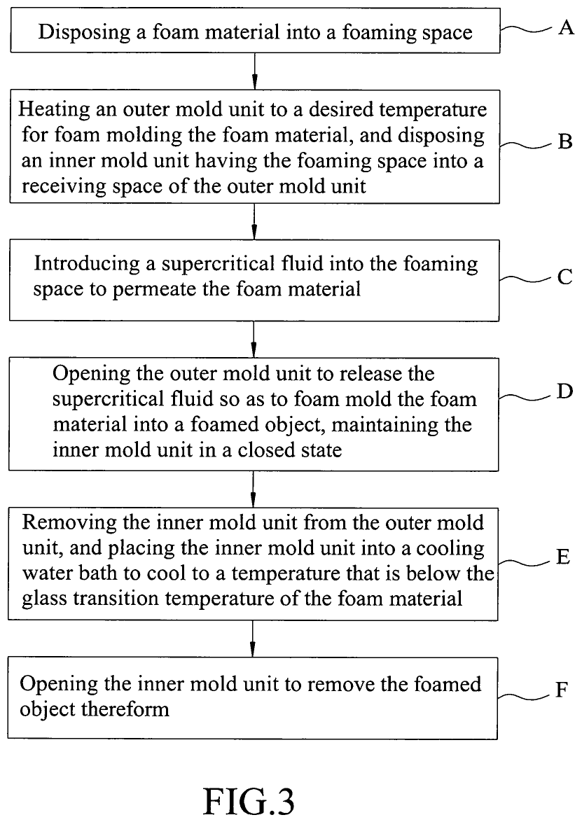

According to this disclosure, the foam molding device may be applied to foam mold a foam material into a foamed object through the following steps A to F (see FIG. 3).

In step A, a foam material is disposed into the foaming space 33 of the inner mold unit 3.

In step B, the outer mold unit 2 is heated to a desired temperature for foam molding the foam material, and then the inner mold unit 3 is disposed into the receiving space 23. Specifically, the outer mold unit 2 is heated by the upper flow module 24 and the lower flow module 25, and the heat can be transferred from the outer mold unit 2 to the inner mold unit 3 disposed in the receiving space 23, so that the inner mold unit 3 can reach the desired temperature.

In step C, a supercritical fluid is introduced into the foaming space 33 so as to permeate the foam material. This step is conducted under a sufficiently high temperature and a sufficiently high pressure to allow the supercritical fluid to permeate into the foam material. For example, this step may be conducted at a temperature ranging between not lower than 90° C. and not higher than 180° C., and at a pressure ranging between not lower than 1000 psi and not higher than 3000 psi.

In step D, the outer mold unit 2 is opened to release the supercritical fluid, so as to foam mold the foam material into the foamed object. Specifically, the pressure in the foaming space 33 is reduced after opening the outer mold unit 2, thereby converting the supercritical fluid to gas that then escapes from the foaming space 33 through the pressure relief holes 34. In this step, the inner mold unit 3 is still in a closed state, enabling the resultant foamed object to maintain its required size and shape without excessive expansion.

In step E, the inner mold unit 3 is removed from the outer mold unit 2, and then is placed into a cooling water tank (not shown in the figures) to be cooled down to a temperature that is below the glass transition temperature of the foam material.

In step F, the inner mold unit 3 is opened to remove the foamed object therefrom. Specifically, after cooling down to a temperature below the glass transition temperature of the foam material, the foamed object that is in a fixed shape without expansion can be removed from the inner mold unit 3.

The advantages of the foam molding device of this embodiment based on the aforesaid features are summarized as follows.

By virtue of detachably disposing the inner mold unit 3 in the outer mold unit 2, the inner mold unit 3 may be removed from the outer mold unit 2 for rapid cooling after a foam molding process conducted under a high temperature and a high pressure. Since the size of the inner mold unit 3 may be much smaller than that of the outer mold unit 2, rapid cooling of the inner mold unit 3, rather than cooling of the whole foam molding device as required in the prior art, enables the manufacturing of the foamed object to be accomplished within a shorter time period. In the meantime, the outer mold unit 2 that still maintains the high temperature for foam molding a foam material may be used in heating another inner mold unit 3 for conducting a foam molding process again after removing the previously used inner mold unit 3 for cooling. Therefore, the outer mold unit 2 of the foam molding device of this disclosure is designed to dispense with reheating and to avoid undesired cooling, thereby shortening the time of the foam molding process.

In addition, since the inner mold unit 3 can be removed from the outer mold unit 2 for cooling, the foamed object can be removed from the inner mold unit 3 after completion of the cooling. Therefore, the size and shape of the foamed object can be fixed by the inner mold unit 3, namely, the foamed object can be prevented from continuously expanding even if the foamed object has a high temperature at the beginning of the cooling. After the cooling is completed, the resultant foamed object without expansion is then removed from the inner mold unit 3. Thus, excessive expansion of the foamed object can be avoided, so as to precisely control the size and shape of the foamed object within a desired range.

Furthermore, by using the inner mold unit 3 made of a material (such as aluminum) having a high thermal conductivity, the temperature of the inner mold unit 3 can be not only elevated quickly through heat conduction after the inner mold unit 3 is disposed in the receiving space 23, but also dropped quickly after the inner mold unit 3 is removed from the outer mold unit 2 for cooling, so that the manufacturing time of the foamed object can be greatly reduced.

By using the outer mold unit 2 made of a material (such as steel) having a high pressure resistance, the outer mold unit 2 can be prevented from being deformed during the foam molding process conducted under a high pressure and a high temperature, thereby achieving an excellent foam molding effect.

Moreover, by virtue of the ejection unit 4 to provide a force to push the inner mold unit 3 away from the outer mold unit 2, the inner mold unit 3 can be conveniently and rapidly removed after completion of the foam molding process, thereby saving the manufacturing time.

By disposing the upper flow module 24 and the lower flow module 25 inside the outer mold unit 2, the outer mold unit 2 can be easily maintained at a desired temperature during the foam molding process, thereby further shortening the manufacturing time.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A foam molding device, comprising:
an outer mold unit including an outer upper mold and an outer lower mold, said outer upper mold and said outer lower mold cooperatively defining a receiving space; and
an inner mold unit detachably disposed within said receiving space and including an inner upper mold and an inner lower mold, said inner upper mold and said inner lower mold cooperatively defining a foaming space adapted for foam molding a foam material into a foamed object.

2. The foam molding device as claimed in claim 1, wherein said inner mold unit has a thermal conductivity that is greater than that of said outer mold unit.

3. The foam molding device as claimed in claim 1, wherein said outer mold unit has a pressure resistance that is greater than that of said inner mold unit.

4. The foam molding device as claimed in claim 1, further comprising an ejection unit disposed in said receiving space.

5. The foam molding device as claimed in claim 4, wherein said ejection unit includes at least one elastic member that is disposed between said outer lower mold and said inner mold unit to provide a force for pushing said inner mold unit away from said outer lower mold.

6. The foam molding device as claimed in claim 1, wherein said outer mold unit further includes an upper flow module and a lower flow module, said upper flow module being disposed in said outer upper mold for heating said outer upper mold, said lower flow module being disposed in said outer lower mold for heating said outer lower mold.

7. The foam molding device as claimed in claim 1, wherein said outer mold unit has a pressure resistance that is higher than 1000 pounds per square inch (psi).

8. The foam molding device as claimed in claim 7, wherein said outer mold unit is made of a steel material.

9. The foam molding device as claimed in claim 1, wherein said inner mold unit has a thermal conductivity that is higher than 50 watts/meter Kelvin (W/mK).

10. The foam molding device as claimed in claim 9, wherein said inner mold unit is made of an aluminum material.

11. The foam molding device as claimed in claim 1, wherein said inner mold unit further includes at least one pressure relief hole that is spatially communicated with inside and outside of said foaming space.
